(19) United States
(12) Patent Application Publication
(10) Pub. No.: US 2011/0045445 A1
(43) Pub. Date: Feb. 24, 2011

(54) Officer under fire perpetrator machine

(76) Inventor: Daniel Joseph Spychalski, Bartlett, IL (US)

Correspondence Address: Daniel J. Spychalski, 758 Spruce Lane, Bartlett, IL, 60103, US

(21) Appl. No.: 12/546,480

(22) Filed: Aug. 24, 2009

(51) Int. Cl. F41G 3/26; F41H 7/02; B62D 11/04

(52) U.S. Cl. 434/23; 89/36.08; 180/6.48; 89/930

(57) ABSTRACT

The Officer Under Fire Perpetrator is a remote-controlled, moving, target human-like in appearance and movements and is comprised of two major components referred to as the base unit and the target body. The base unit houses all components, consisting of a chassis plate (moved by: four electric motor/wheel assemblies) housed within an armor box providing protection from bullets. This system provides live-video footage to assist human trainer, remote-control operation, in addition to post-training review as shootout scenarios unfold. An electronic sighting system is displayed on live video, ensuring the training weapon's accuracy while shooting training projectiles at trainees. Equipped with a moving target body arm, the human-appearing target body is capable of withstanding numerous bullet hits and mounts into the base unit. This allows for a simulated firearms range shootout between the O.U.F. Perpetrator firing training projectiles, as a trainee is firing bullets upon the target's body.

### TECHNICAL FIELD

The present invention relates to a mobile, remote-controlled, human-like in appearance, firearm target system that shooting training projectiles while video recording which assists in targeting shooters in a shooting range or other training environment while also providing the benefit post training video review to assist in the training process.

### BACKGROUND

Mobile, human appearing target systems are well known to be in existence, especially in police and military training. Many of these systems are remote-controlled, powered by electrically driven motors, cable and pulley or chain and sprocket systems. Other simulated firearms training systems have rely upon a video screen which simulates scenarios where the trainee/shooter must respond appropriately and fire shots on a target or video screen when appropriate. These existing systems have often rely upon a simulated firearm that lacks realism in that real ammunition is not fired during the training process. As a result, there is a lack of weapon recoil and can lead trainees to have the perception that more parallels with that of a video game with regards to a video screen simulation. Secondly, existing moving, human-appearing targets do not adequately create realistic stress inoculation and impose a physical threat since existing moving targets do not shoot accurately from the target the trainee is firing upon. One example of a typical video screen firearm simulation system is set forth in U.S. Pat. No. 5,215,464 issued on Jun. 1, 1993 to Marshall; Albert H. (Orlando, Fla.), Wolff; Ronald S. (Cocoa, Fla.), Purvis; Edward J. (Winter Park, Fla.), McCormack; Robert T. (Merritt Island, Fla.). A second prior art example of a moving shooting target is set forth in U.S. Pat. No. 7,614,626 issued on Nov. 10, 2009 to Aanerud; Richard R. and Aanerud; Laura A.

### SUMMARY OF THE INVENTION

The present invention consists of major components being a chassis pan which houses electronics, drive motor attached to wheels that provide independent movement initiated by remote-control. Also contained onto the chassis pan is a training weapon which in this embodiment is a commonly available paintball gun, however other projectile weapons will suffice. Said weapon fires training projectiles that are fired at velocity rates far slower than that of real firearms projectiles allowing human trainees to be fired upon while only needing to wear minor safety equipment. Said training weapon's aim is assisted by a mechanical or electronic sighting system sighted in with said training weapon. Sighting system is positioned in front of a wireless transmitting video camera that provides live feedback for the target system operator to effectively move said invention and target firearms trainees, while firing training projectiles for a realistic shooting scenario typically recreated by security, law enforcement and military personnel. Affixed to the top of the unit sub plate is a pneumatically activated bracket which provides pulling force to actuate movement of the human-appearing target body that is pulled in this embodiment by a cable or similar material that is bullet resistant. An armor box assembly surrounds the components affixed to the unit sub plate for the purpose of protection from inadvertent bullets fired low that occasionally may miss the human-appearing target body. The armor box contains a mounting provision for transparent, protective material that shields the camera allowing a clear and unobstructed view of the shooting range and trainee(s). Mounted atop the unit box is a removable cover with access panel that allows access for servicing invention. The unit box has two mounting provisions for the human-appearing target body that slides in and out for easy removal and installation. Mounted within the target is a reactive target plate which provides hit indication in the event that a firearm trainee successfully landed a bullet in a desired location.

### SUBSTITUTE SPECIFICATION STATEMENT

This substitute specification includes no new matter.

### BRIEF DESCRIPTION OF THE DRAWINGS

FIG. 1 displays the complete invention in current embodiment with the target body mounted into main drive unit;

FIG. 2, SECTION K-K displays a top view of the main drive unit cover, displaying the protruding training weapon in the current embodiment;

FIG. 3, SECTION L-L displays the bottom view of the main drive unit displays wheel and motor drive assembly, with outer portions beyond square area displaying training weapon in the right upper corner of square area and target body arms and demo weapon shown;

FIG. 4, SECTION C-C at a right side 45 degree viewing angle of the main drive unit, displays mechanicals related to the movement of the target body movable arm;

FIG. 5, SECTION D-D at a right side 45 degree viewing angle of the main drive unit, displays mechanicals related to the training weapon pellet filler flange opening, mounting and movement of training weapon as well as the camera mounting plate;

FIG. 6, SECTION F-F displays at a nearly frontal viewing angle, removable panels of the unit box as well as the resilient mount for box attaching to the unit sub-plate;

FIG. 7, SECTION E-E displays at a right side 45 degree viewing angle, drive motor and wheel components affixed to the underside of the unit sub plate as well as position feedback camera and window contained underneath removable cover;

FIG. 8, SECTION A-A displaying a right side 45 degree viewing angle of the drive unit, the training weapon at an elevated position with related movement of the camera and slideable window;

FIG. 9, displays a side sectional view of the target body and reactive plate mounted within;

FIG. 10, displays a top view of the target body, main drive unit cover with cable and cable cut out in cover lid;

FIG. 11, SECTION B-B displays a front viewing angle of the main drive unit, displaying the training weapon at an elevated position;

FIG. 12, displays the air piston and assembly in a retracted condition with causation of movable arm in down position;

FIG. 13, displays the air piston and assembly in an extended position with causation of movable arm in the up position;

FIG. 14, displays a wiring schematic of the electrical system in current invention.

### DETAILED DESCRIPTION

Referring to FIG. 1, the complete invention is displayed with the target body 10 and target body legs 28, with attached movable arm 2 and demo weapon 3 that responds to pull input from cable 13, and movements initiated from main drive unit 4, with removable cover 33, displaying training weapon 5 with independent upward and downward elevation.

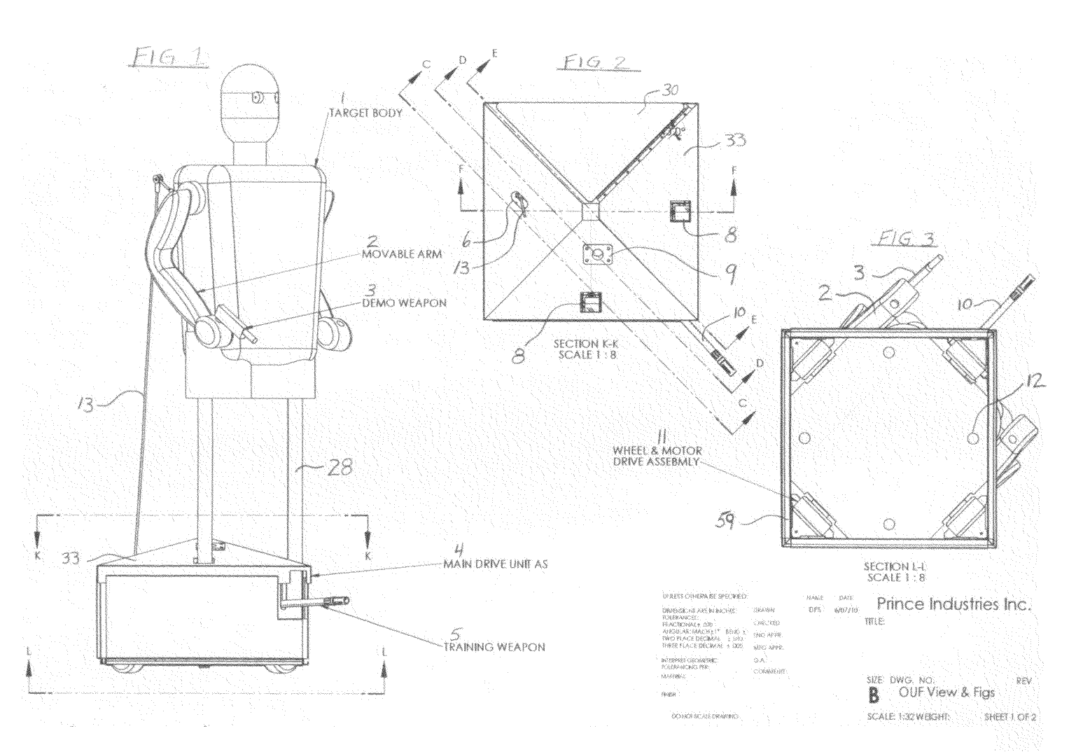

Referring to FIG. 2, the removable cover 33 is shown atop of main drive unit 4 as in FIG. 1, displays cable cutout 6 with cable 13 protruding through the center of said cutout 6, target body leg cutouts 8 allow target body legs to be inserted for mounting in main drive unit 4 and pellet filler flange 9 allows refilling training weapon 10, access panel 30 allows internal access of main drive unit 4 without removal of removable cover 33.

Referring to FIG. 3, the bottom view of the main drive unit 4 is displayed, showing wheel and motor drive assembly 11, resilient mount bolts 12 are shown which protrude away from bottom view providing mounting for unit sub-plate 27. Target body movable arm 2, demo weapon 3 and training weapon 10 are viewable outside of unit box 59.

Referring to FIG. 4, the arm actuator air cylinder 16 is attached to a cylinder mount pin 17, as rod end of 16 attaches to arm actuator bracket 14, which then is affixed to cable as to arm 13 by way of a pivot pin 44, target body leg 28 is displayed along with attached target body 1.

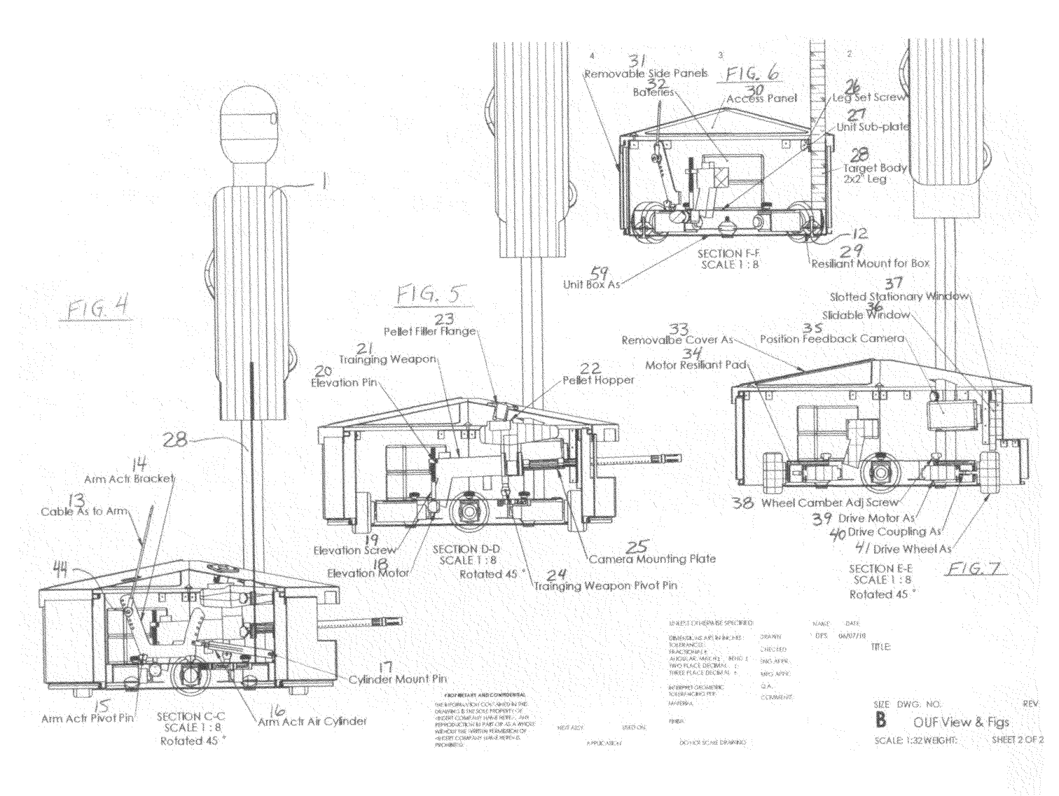

Referring to FIG. 5, the elevation motor 18 is affixed to the underside of the unit sub plate 27 and the elevation screw 19 is affixed onto the motor shaft of 18 which is attached to the elevation pin nut 20 which has causation to raise and lower upon rotation of elevation screw 19 caused by elevation motor 18, thereby 20 is affixed to training weapon 21 which is mounted centrally upon training weapon pivot pin 24, allowing muzzle end to raise and lower opposite direction of elevation pin nut 20, raising and lowering.

The camera mounting plate 25 and pellet hopper 22 raises and lowers in conjunction with training weapon 10.

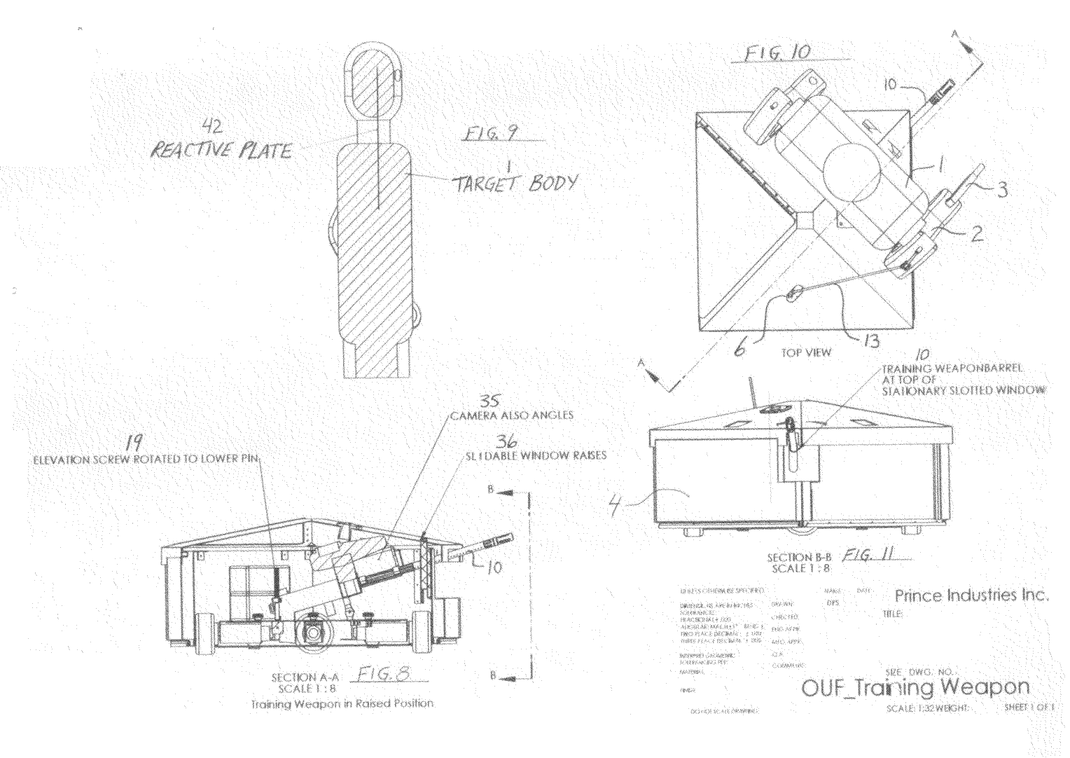

Referring to FIG. 6, the unit box as 59 is surrounded by removable side panels 31 assist in protection of internal components such as batteries 32, from inadvertent bullets or projectile fire which could otherwise be damaged, while an access panel 30 allows easy access of main drive unit 4 internals such as a leg set screw 26 that secures target body leg 28 that rests upon the unit sub plate 27 with mounting by way of resilient bushing mount for box 29 with resilient mount bolts 12.

Referring to FIG. 7, the removable cover 33 mounts atop of main drive unit 4 and displayed is a drive motor 39 mounted upon motor resilient pads 34 to the unit sub plate 27.

Drive motor 39 is affixed to a drive coupling 40, affixed to a drive wheel 41 with camber adjustment by way of a wheel camber adjusting screw 38.

Slideable window 36 and slotted stationary window 37 provide transparent protection while positioned fore of the position feedback camera 35.

Referring to FIG. 8, the elevation screw 19 rotation has causal effect lower rear of training weapon 10, while camera 35 angles as the slidable window 36 raises.

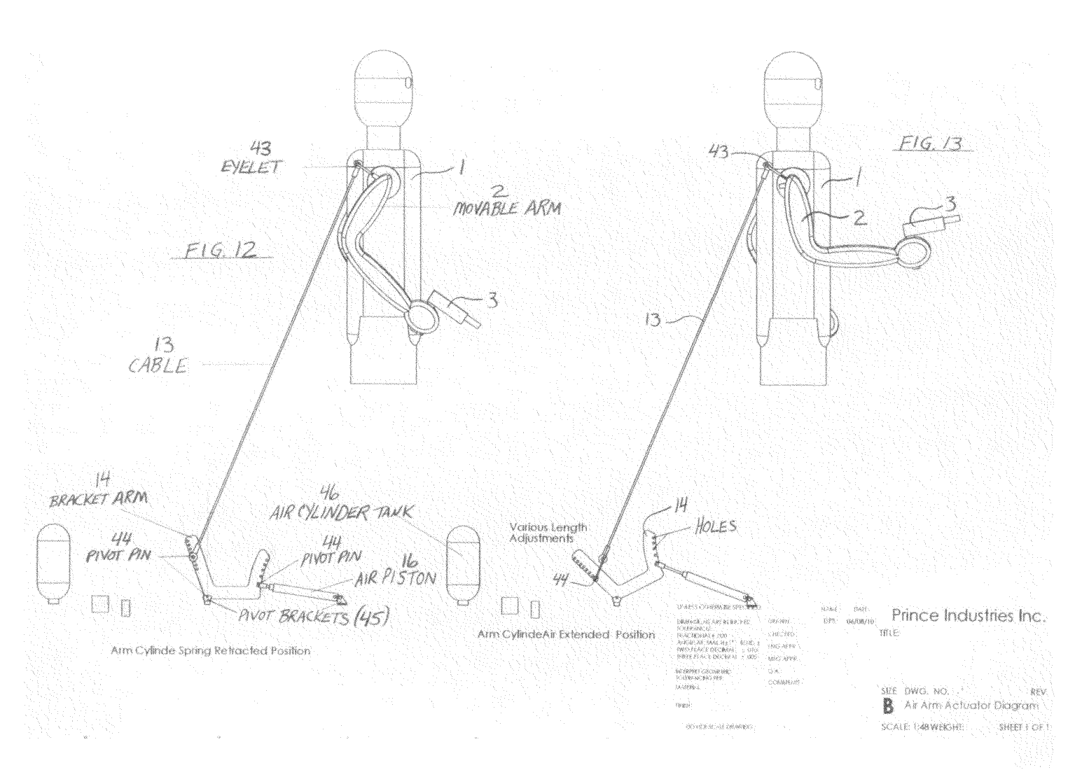

Referring to FIG. 9, the target body 1 is displayed at a right side view, a cut away view, displaying internal reactive plate 42 typically made of a bullet resistant material that reacts by way of movement and audible report when impacted by bullets and projectiles.

Referring to FIG. 10, a top view of the removable cover 33 is displayed having cable 13 protrude through cable cutout 6 having causation of motion upon movable arm 2 and demo weapon 3, attached to target body 1, as training weapon is displayed outside of removable cover 33.

Referring to FIG. 11, a frontal view of the main drive unit 4, displaying training weapon 10 in an elevated position.

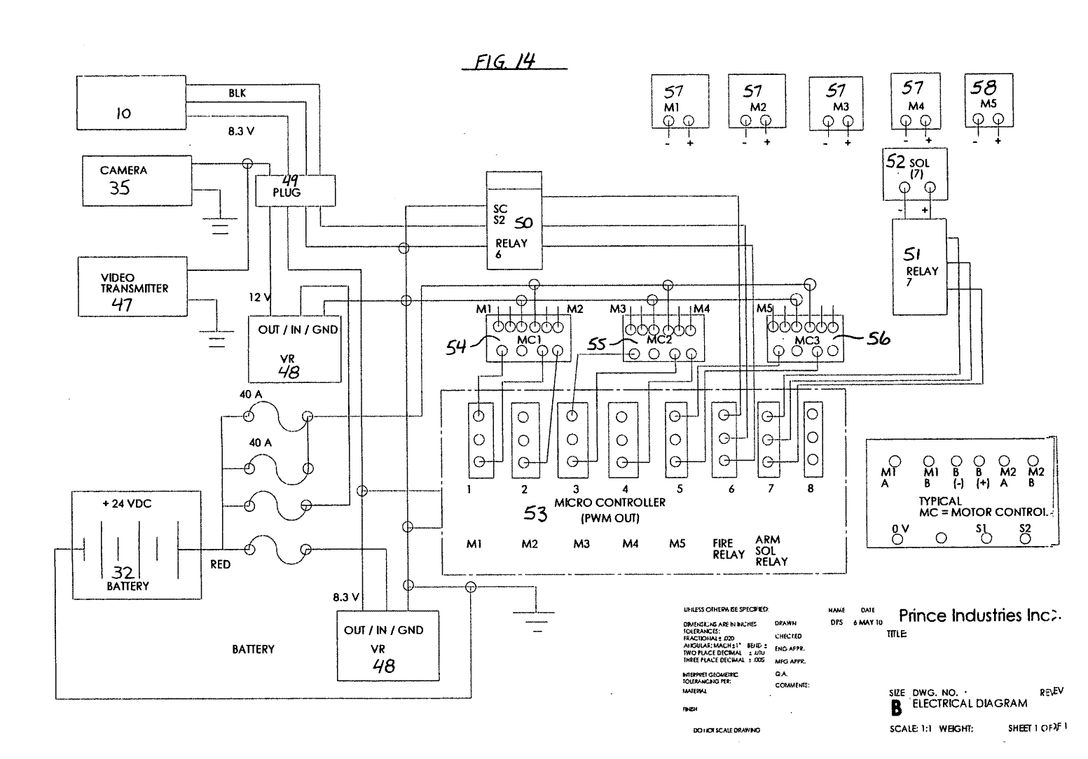

Referring to FIG. 12, a side view of the target body 1, with attached movable arm 2 and demo weapon 3, affixed to cable 13, then affixed to bracket arm 14 by way of a pivot pin 44, and said bracket arm 14 pivots upon a pivot pin 44 and pivot bracket 45, with motion causation by attached air piston 16 powered by air cylinder tank 46, with current piston position retracted as movable arm 2 and demo weapon position 3 is down.

Referring to FIG. 13, a side view of the target body 1, with attached movable arm 2 and demo weapon 3, affixed to cable 13, then affixed to bracket arm 14 by way of a pivot pin 44, and said bracket arm 14 pivots upon a pivot pin 44 and pivot bracket 45, with motion causation by attached air piston 16 powered by air cylinder tank 46, with current piston position extended as movable arm 2 and demo weapon position 3 is up.

Referring to FIG. 14, is a wiring schematic displaying a 24 volt DC battery 32, which supplies 24 volts DC powering two voltage regulators 48, with output voltages set at 8.3 volts and 12 volts. The 8.3 volt circuit then powers the microcontroller 53 which accepts remote controlled radio frequency from manual human inputs, with corresponding pulse width modulation outputs shown on 53 as PWM out with numbered outputs used 1, 2, 3, 4 and 5 providing input voltage to corresponding motor controllers 54, 55, 56 with corresponding 24 volts DC output power to drive motors M1 57, M2 57, M3 57, M4 57 and elevation motor M5 58. PWM outputs 6 and 7 provide signal voltage input to training weapon fire relay 6 50 by way of input voltage going to training weapon 10 pc board switch resulting in firing training weapon 10. Movable arm relay 7 51, when energized with 24 volts DC in this embodiment, activates solenoid 7 52 which allows pneumatic air pressure to extend the air piston, having causal effect of pulling cable and raising movable arm 2 and demo weapon 3.

The 12 volt circuit from second voltage regulator 48 provides power for video camera 35 and wireless video transmitter 47 and matched video receiver can be plugged into any TV screen or monitor for live operational viewing and recording.

Referring to microcontroller 53, listed is the source code related to human inputs upon remote controlled transmitter and causal effect upon PWM outputs from microcontroller 53 to said motor controllers 54, 55, 56 and relay 50, relay 51 functions;

Programming ‘C’ Language Source Code

/***********************************************************************

FILE NAME: user_routines.c

***********************************************************************/

| | |
|---|---|
| #include “aliases.h” | /* external libraries and include files */ |

| #include “default.h” | | |
|---|---|---|
| #include “utilities.h” | | |
| #include “user_routines.h” | | |
| #include “printf_lib.h” | | |
| #define SOFTWARE_VERSION | 3 /* version # */ | |
| #define BUTTON_REV_THRESH | 67 | /* threshold values */ |

| | |
|---|---|
| #define BUTTON_FWD_THRESH | 187 |
| #define NEUTRAL_VALUE | 127 |
| #define PWM_THRESH_MAX | 154 |
| #define PWM_THRESH_MIN | 100 |
| #define PIR_THRESH_MIN | 460 |
| #define PIR_THRESH_MAX | 600 |

#

/* PWM source control register */

static void Controls_Pwms(int pwmSpec1,int pwmSpec2,int pwmSpec3,int pwmSpec4,

int pwmSpec5,int pwmSpec6,int pwmSpec7,int pwmSpec8)

{

txdata.pwm_mask = 0xFF;
if (pwmSpec1 == USER)

txdata.pwm_mask &= 0xFE;

if (pwmSpec2 == USER)

txdata.pwm_mask &= 0xFD;

if (pwmSpec3 == USER)

txdata.pwm_mask &= 0xFB;

if (pwmSpec4 == USER)

txdata.pwm_mask &= 0xF7;

if (pwmSpec5 == USER)

txdata.pwm_mask &= 0xEF;

if (pwmSpec6 == USER)

txdata.pwm_mask &= 0xDF;

if (pwmSpec7 == USER)

txdata.pwm_mask &= 0xBF;

if (pwmSpec8 == USER)

txdata.pwm_mask &= 0x7F;

}
/***********************************************************************
* FUNCTION NAME: Initialization
* PURPOSE: This routine initializes all the values
* CALLED FROM: main.c
* ARGUMENTS: none
* RETURNS: void
***********************************************************************/
void Initialization (void)
{

/* Analog input pins */

IO9 = INPUT;
IO10 = INPUT;

/* Number of analog channels. */

Set_Number_of_Analog_Channels(TWO_ANALOG);

/* Initialize pwm values */

pwm01 = pwm02 = pwm03 = pwm04 = pwm05 = pwm08 = 127;
pwm06 = pwrn07 = 0;

/* pwm controls */

Controls_Pwms(MASTER,MASTER,MASTER,MASTER,MASTER,MASTER,MASTER,MASTER);

/* pwm output types */

Setup_PWM_Output_Type(MAIN_PWM,MAIN_PWM,MAIN_PWM,MAIN_PWM);

/* initialize serial comms */

Initialize_Serial_Comms( );
Putdata(&txdata);
User_Proc_Is_Ready( );

#ifdef_SIMULATOR

statusflag.NEW_SPI_DATA = 1;

#else

while (!statusflag.NEW_SPI_DATA);
Getdata(&rxdata);
printf(“User v%d\n”,(int)SOFTWARE_VERSION);

#endif
}
/***********************************************************************
* FUNCTION NAME: Process_Master_uP
* PURPOSE: Executes every 17ms
* CALLED FROM: main.c
* ARGUMENTS: none
* RETURNS: void
***********************************************************************/
void Process_Master_uP(void)
{

Getdata(&rxdata);
Routine( );
Putdata(&txdata);

}
/***********************************************************************
* FUNCTION NAME: Routine
* CALLED FROM: this file
* ARGUMENTS: none
* RETURNS: void
***********************************************************************/
void Routine(void)
{

/* Initialize all variables */
static unsigned int IR_sensor1, IR_sensor2, CCW_flag = 0, CW_flag = 0, laser_flag = 0, ACTUATE = 0,

ACTUATE2 = 0;

static unsigned int gun_arm_flag = 0, gun_drop_flag = 0, barrel_safe_ctr = 0;
static unsigned int i=0, j=0, k=0, m=0, n=0;

/* Initialize PWM values */

pwm01 = pwm02 = pwm03 = pwm04 = pwm05 = pwm08 = 127;

/* Initialize PIR delay*/

k = 0;
k++;
if (k > 1000) k = 1000;

/* Assign analog input values to PIR sensors */

IR_sensor1 = Get_Analog_Value(rc_ana_in09);
IR_sensor2 = Get_Analog_Value(rc_ana_in10);

/* Fire control */

if (PWM_in6 > BUTTON_FWD_THRESH)

pwm06 = 0x7f;

else pwm06 = 0;

/* Laser duration */

if ( j >= 240 )
{

j = 0;
laser_flag = 0;

}

/* Hold active arm in raised position */

if ( m >= 60 )
{

gun_arm_flag = 0;
pwm05 = 155;
if (!(laser_flag))
{

m = 0;
gun_drop_flag = 1;

}

}

/* Lower active arm */

if (gun_drop_flag)
{

pwm05 = 80;
n++;

}

/* Hold active arm in down position */

if ( n >= 40 )
{

gun_drop_flag = 0;
n = 0;
pwm05 = 127;

}

/* Laser control */

if (PWM_in6 < BUTTON_REV_THRESH)
{

laser_flag = 1;
gun_arm_flag = 1;

}

/* Initiate active arm circuit if laser actuated */

if (laser_flag)
{

pwm07 = 0x7f;
j++;

}
else
{

pwm07 = 0;

}

/* Raise active arm */

if ( (gun_arm_flag) && (m < 60) )
{

pwm05 = 190;
m++;

}

/* Weapon elevation control */

pwm08 = PWM_in3;
if (pwm08 < 127) pwm08 = PWM_in3 * 0.6 + 51;
else pwm08 = PWM_in3 * 0.55 + 57;

/* Initiate safe counter if stick fully actuated for barrel protection */

if ( (PWM_in3 > 230) ∥ (PWM_in3 < 25) )
{

barrel_safe_ctr++;

}
else barrel_safe_ctr = 0;
if (barrel_safe_ctr > 120) pwm08 = pwm08 * 0.6 + 51;

/* Twist duration */

if ( i >= 60 )
{

i = 0;
CCW_flag = 0;
CW_flag = 0;

}

/* Twist at full speed CCW ~0.5 seconds */

if ( (PWM_in1 > 240) && (PWM_in4 < 15) && (!(CW_flag)) ) CCW_flag = 1;
if ( CCW_flag )
{

pwm01 = 0;
pwm02 = 0;
pwm03 = 255;
pwm04 = 255;
i++;
return;

}

/* Twist at full speed CW ~0.5 seconds */

if ( (PWM_in1 < 15) && (PWM_in4 > 240) ) CW_flag = 1;
if (CW_flag)
{

pwm01 = 255;
pwm02 = 255;
pwm03 = 0;
pwm04 = 0;
i++;
return;

}

/* Diagonal motion */

else if ( ((PWM_in1 < PWM_THRESH_MIN) ∥ (PWM_in1 > PWM_THRESH_MAX)) &&

((PWM_in2 < PWM_THRESH_MIN) ∥ (PWM_in2 > PWM_THRESH_MAX)) )

{

pwm01 = pwm03 = PWM_in1;
pwm02 = pwm04 = 255 − PWM_in2;

}
else
{

/* Only lateral motion so twisting enabled */

if ( (PWM_in1 < PWM_THRESH_MIN) ∥ (PWM_in1 > PWM_THRESH_MAX) )

{

pwm01 = pwm03 = PWM_in1;
pwm02 = PWM_in4 * 0.4 + 77;
pwm04 = (255 − PWM_in4) * 0.4 + 77;

}

/* Only forward/reverse motion so twisting enabled */

if ( (PWM_in2 < PWM_THRESH_MIN) ∥ (PWM_in2 > PWM_THRESH_MAX) )
{

pwm02 = pwm04 = 255 − PWM_in2;
pwm01 = PWM_in4 * 0.4 + 77;
pwm03 = (255 − PWM_in4) * 0.4 + 77;

}

/* No straight line motion so twisting enabled */

if ( (PWM_in1 > PWM_THRESH_MIN) && (PWM_in1 < PWM_THRESH_MAX) &&

(PWM_in2 > PWM_THRESH_MIN) && (PWM_in2 < PWM_THRESH_MAX) )

{

if ( (PWM_in4 > PWM_THRESH_MIN) && (PWM_in4 < PWM_THRESH_MAX) )
{

/* No Ch. 1, 2, or 4 input so auto-tracking circuit enabled */

```
  if (k > 950)
  {
```

```
if ( (IR_sensor1 < PIR_THRESH_MIN) ∥ (IR_sensor1 > PIR_THRESH_MAX) )
{
  pwm01 = 168;
  pwm02 = 168;
```

What claimed is:

1. Mobile base unit with four remote controlled motors causing rotation of multi-direction wheels causing motions of: fore and aft, left and right, four way diagonal and rotation in clockwise and counterclockwise directions and combined motions of rotation in either clockwise and counterclockwise and fore of aft or left or right motion and with pulse motor activations for fine rotation modulation.

2. Claim 1 with target body of various humanoid or other figures.

3. Target body with movable body parts or appendages that has adjustable motion.

4. Target Body with hit indication.

5. Claims 1 and 2 with training weapon attached.

6. Training weapon with variable elevation adjustment.

7. Training weapon with wireless camera with protective window for operator feedback of base unit position and weapon target acquisition.

8. Camera with target indicator by way of an electronic or other sighting indicator in frame of view.

9. Remote controlled mobile drive unit as in claim 1 with multi direction wheels that have camber adjustment.

10. Remote controlled mobile drive unit as in claim 1 with separate armor plates that can be replaced and has motion deflection to reduce bullet ricochet.

11. Remote controlled mobile drive unit as in claim 1 with armor plates that may contain bullet proof liner inserts.

12. Remote controlled mobile drive unit as in claim 1 with removable subplate for access to motor and controls.

13. Remote controlled mobile drive unit as in claim 1 with removable top cover

14. Remote controlled mobile drive unit as in claim 1 with removable and/or accessible accessories such as batteries and compressed air tank.

15. Remote controlled mobile drive unit as in claim 1 with a training weapon that can be removed without tools by way of pull pins or other retaining devices.

16. Remote controlled mobile drive unit as in claim 1 that has removable target body supports mounting the target body onto to base unit.

17. Remote controlled mobile drive unit as in claim 1 that has access cover for replacement of battery and compressed air tank.

18. Remote controlled mobile drive unit as in claim 1, along removable top cover as in claim 13, having an access port and cover for reloading training weapon with projectiles.

19. Remote controlled mobile drive unit as in claim 1 that has motor suspension.

20. Remote controlled mobile drive unit as in claim 1 that has suspension between sub plate and the main enclosure.
